(19) United States
(12) Patent Application Publication
(10) Pub. No.: US 2019/0196690 A1
(43) Pub. Date: Jun. 27, 2019

(54) FIRST-PERSON ROLE PLAYING INTERACTIVE AUGMENTED REALITY

(71) Applicant: Zyetric Virtual Reality Limited, Kowloon (HK)

(72) Inventors: Peter Han Joo CHONG, Kowloon (HK); Pak Kit LAM, Kowloon (HK)

(73) Assignee: Zyetric Virtual Reality Limited, Kowloon (HK)

(21) Appl. No.: 16/290,638

(22) Filed: Mar. 1, 2019

Related U.S. Application Data
(63) Continuation of application No. PCT/US2018/039117, filed on Jun. 22, 2018.
(60) Provisional application No. 62/524,443, filed on Jun. 23, 2017.
(60) Provisional application No. 62/667,271, filed on May 4, 2018.

(51) Int. Cl. G06F 3/0481; G06T 19/00; G02B 27/01; G06F 3/041; G06K 9/00

(52) U.S. Cl. CPC G06F 3/04815; G06T 19/006; G06K 9/00335; G06F 3/041; G02B 27/017

(57) ABSTRACT

At an electronic device having a display and one or more image sensors, a view of an augmented reality (AR) environment is displayed, wherein the AR environment includes a background based on captured image data from the one or more image sensors and a first virtual object at a first location and the view includes display of the first virtual object. Movement data indicating movement of a remote user is received. A property is determined of the first virtual object in the AR environment based on the received data. The display of the view is updated based on the determined property.

### CROSS-REFERENCE TO RELATED APPLICATIONS

This application is a continuation of International Patent Application No. PCT/US18/39117, “FIRST-PERSON ROLE PLAYING INTERACTIVE AUGMENTED REALITY,” filed Jun. 22, 2018, which claims priority to U.S. Provisional Patent Application Ser. 62/524,443, entitled “FIRST-PERSON ROLE PLAYING INTERACTIVE AUGMENTED REALITY,” filed Jun. 23, 2017, U.S. Provisional Patent Application Ser. 62/667,271, entitled “FIRST-PERSON ROLE PLAYING INTERACTIVE AUGMENTED REALITY,” filed May 4, 2018. The content of each is hereby incorporated by reference for all purposes.

### FIELD

The present disclosure relates to augmented reality (AR) environments and, more specifically, to interacting with AR environments.

### BACKGROUND

Virtual reality (VR) environments are entirely or mostly computer generated environments. While they may incorporate images or data from the real world, VR environments are computer generated based on the parameters and constraints set out for the environment. In contrast, augmented reality (AR) environments are largely based on data (e.g., image data) from the real world that is overlaid or combined with computer generated objects and events. Aspects of these technologies have been used separately using dedicated hardware.

### SUMMARY

Below, embodiments of inventions are described allow for interaction with AR environments using data detected from different users who are connected via a network.

In some embodiments, at an electronic device having a display and one or more image sensors, a view of an augmented reality (AR) environment is displayed, wherein the AR environment includes a background based on captured image data from the one or more image sensors and a first virtual object at a first location and the view includes display of the first virtual object. Movement data indicating movement of a remote user is received. A property is determined of the first virtual object in the AR environment based on the received data. The display of the view is updated based on the determined property.

### BRIEF DESCRIPTION OF THE FIGURES

The present application can be best understood by reference to the figures described below taken in conjunction with the accompanying drawing figures, in which like parts may be referred to by like numerals.

FIG. 1A depicts an exemplary electronic device that implements some embodiments of the present technology.

FIG. 1B depicts an exemplary electronic device that implements some embodiments of the present technology.

FIG. 2 depicts an example IAR background.

FIG. 3 depicts an example IAR background with an example IAR object.

FIG. 4 depicts an example IAR background that is capturing an IAR gesture.

FIG. 5 depicts an example IAR background that is capturing an IAR gesture and has an example IAR object.

FIG. 6 depicts an example headset for mounting a smart device.

FIG. 7 depicts an IAR object that is associated with a remote user of a head mounted smart device.

FIG. 8 depicts an IAR view with an IAR object that is associated with a remote user and moves based on received displacements and a reference location.

FIG. 9 depicts example gestures for interacting with an IAR view.

FIG. 10 depicts example gestures for interacting with an IAR view.

FIG. 11 depicts example gestures for interacting with an IAR view.

FIG. 12 depicts an IAR object controlled by a remote user being launched at the user of the smart device viewing the displayed IAR view.

FIG. 13 depicts an IAR object controlled by a remote user being launched at the user of the smart device viewing the displayed IAR view.

FIG. 14 depicts an IAR view with IAR objects associated with two different remote users.

FIG. 15 depicts a system, such as a smart device, that may be used to implement various embodiments of the present invention.

FIG. 16A depicts an example gesture in accordance with various embodiments of the present invention.

FIG. 16B depicts an example gesture in accordance with various embodiments of the present invention.

FIG. 17A depicts another example gesture in accordance with various embodiments of the present invention.

FIG. 17B depicts another example gesture in accordance with various embodiments of the present invention.

FIG. 18A depicts yet another example gesture in accordance with various embodiments of the present invention.

FIG. 18B depicts yet another example gesture in accordance with various embodiments of the present invention.

FIG. 18C depicts yet another example gesture in accordance with various embodiments of the present invention.

FIG. 18D depicts yet another example gesture in accordance with various embodiments of the present invention.

FIG. 19A depicts further example gestures in accordance with various embodiments of the present invention.

FIG. 19B depicts further example gestures in accordance with various embodiments of the present invention.

FIG. 19C depicts further example gestures in accordance with various embodiments of the present invention.

FIG. 19D depicts further example gestures in accordance with various embodiments of the present invention.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the present technology. Thus, the disclosed technology is not intended to be limited to the examples described herein and shown, but is to be accorded the scope consistent with the claims.

In embodiments of the present technology, two or more players take a first-person role in playing an augmented reality (AR) game. In the some augmented reality (AR) games, one or more players usually play against the “virtual” objects controlled by the computer (e.g., the CPU or other controlling device inside the smart device or in a remote server). This kind of AR game can make use of the AR technology to enhance the gaming experience for the players. These AR games, however, do not allow two or more users to play with “first-person-role-playing” experience inside the AR environment. In other words, these AR games are still based on some traditional mindset in which the players still play against the computer, and do not take the full advantage of the abilities that AR technologies can provide according to embodiments of the present invention, some of which are described below. Some embodiments of the “first-person-role-playing” technology described herein significantly enhance the interactivity between multiple players, which can potentially open up a new directions and areas in the AR gaming.

Some embodiments of the invention improve the AR gaming experience by allowing the players to play against each other by controlling virtual objects in a first-person-role-playing manner. This produces a perception of two or more players that are really playing against each other in real-time inside an AR environment instead of against a computer-controlled virtual object.

Using an example game similar to the popular AR game—Pokemon Go—as an example. Using current technology, once a virtual object (e.g., a creature) is detected to be within the vicinity, the player can throw a trap to catch the creature. In this situation, the player (“P1”) can control the trap, but the creature is controlled by the CPU of the smart device.

In some embodiments of the present technology, a second player (“P2”) is controlling the creature in a first-person-role-playing manner through P2's actual body movements. The creature is not controlled by the smart device CPU or some other computer. In other words, P2 is “seen” as the creature on P1's smart device, and he/she will interactively avoid the traps thrown to him/her by P1 through moving his/her body (e.g., to either the left or right side). At the same time, P1 is seen as the trapper on P2's smart device. Note that P1 and P2 can be located in different parts of the world, and the meta-data of his/her movements can be sent over the Internet or other network between each other, providing their smart devices (e.g., AR/VR goggles) are connected to the Internet or network through Wi-Fi, cellular, or wired networks.

Once the example game begins, P2 perceives the trap as a virtual object on P2's AR/VR goggle, being thrown to him from P1, who is depicted as the trapper on his AR environment. Upon seeing the trap, P2 can move aside to avoid being hit by the trap. At this time, P1 actually sees the creature, which is a virtual object controlled by P2, moving away from the trajectory of the trap P1 throws at it. P1 may then change the angle of the next throw to aim at where P2 is moving. Below, the following concepts are used to describe some embodiments of the present technology:

Local Object—The objects that are “local” to the user and are not “seen” from the front- or back-facing camera. In other words, these are computer generated objects being displayed on the screen of the smart device but are not part of the AR and/or VR environment in a way that is accessible to other users.

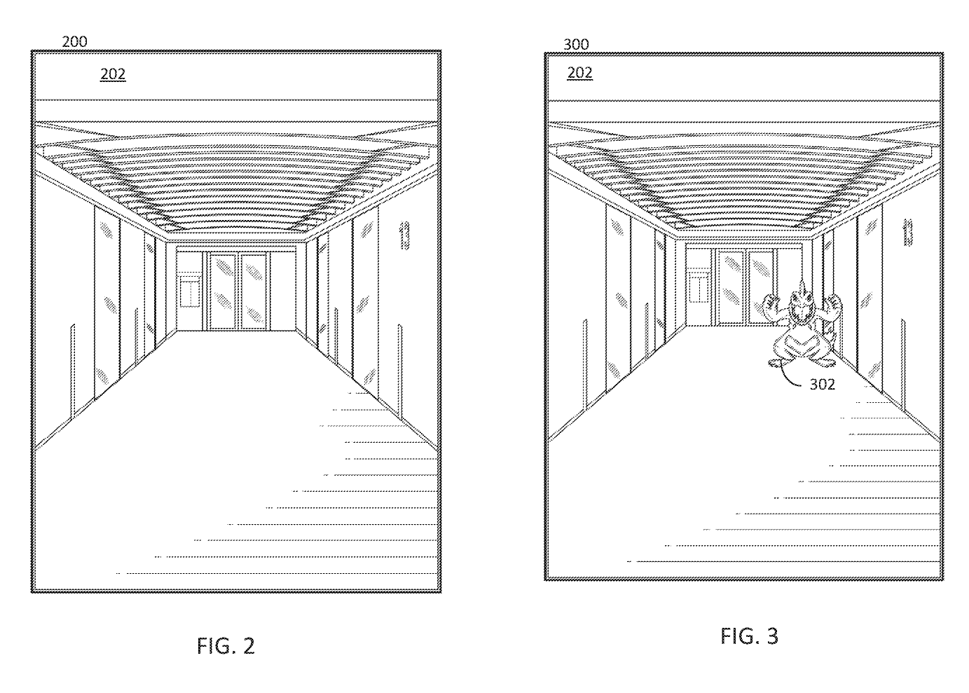

IAR Background—The real-time “background” view seen from the back-facing camera in some IAR games (e.g., card games or create-capturing games) or applications. FIG. 2 depicts an example.

IAR Object—The computerized object overlaid onto the IAR Background. In contrast to local objects, these objects are shared among other users (when present) of the AR and/or VR environment. FIG. 3 depicts an example.

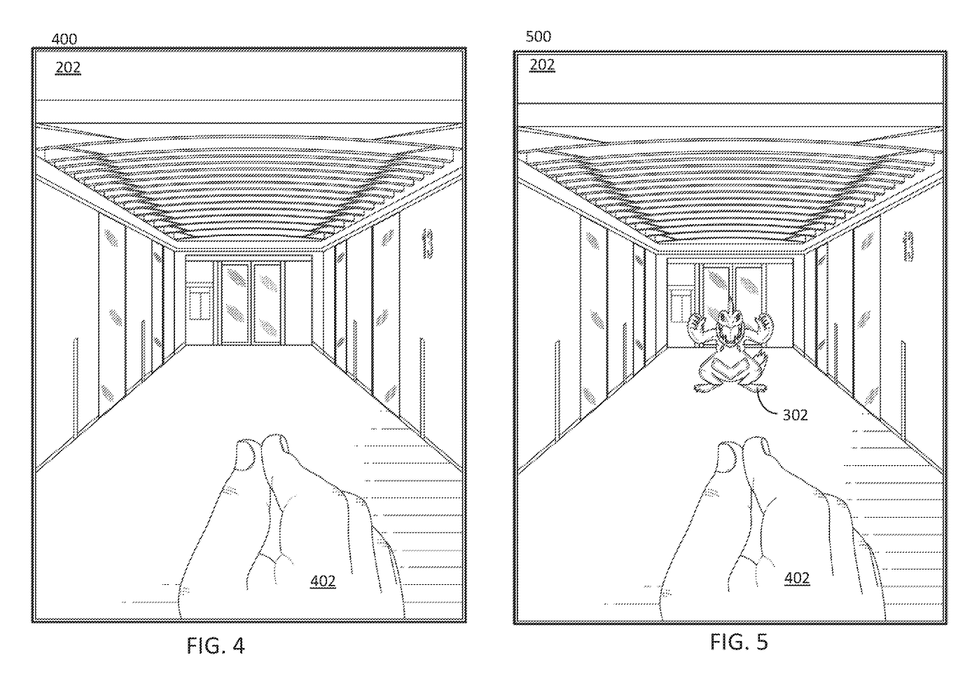

IAR Gesture—A general term referring to a hand gesture or a series of hand gestures recognized by the back-facing camera or other sensors. FIG. 4 depicts an example.

IAR View—A display of the combined IAR Background and IAR Object(s) and/or Local Object(s). For example, the view generated from a specific vantage point in an AR and/or VR environment. FIG. 5 depicts an example.

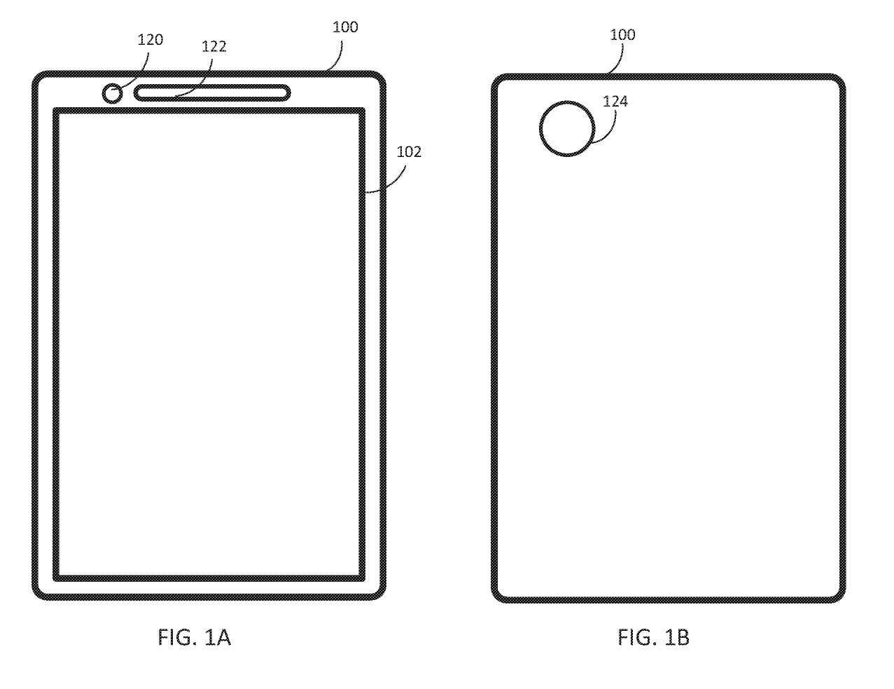

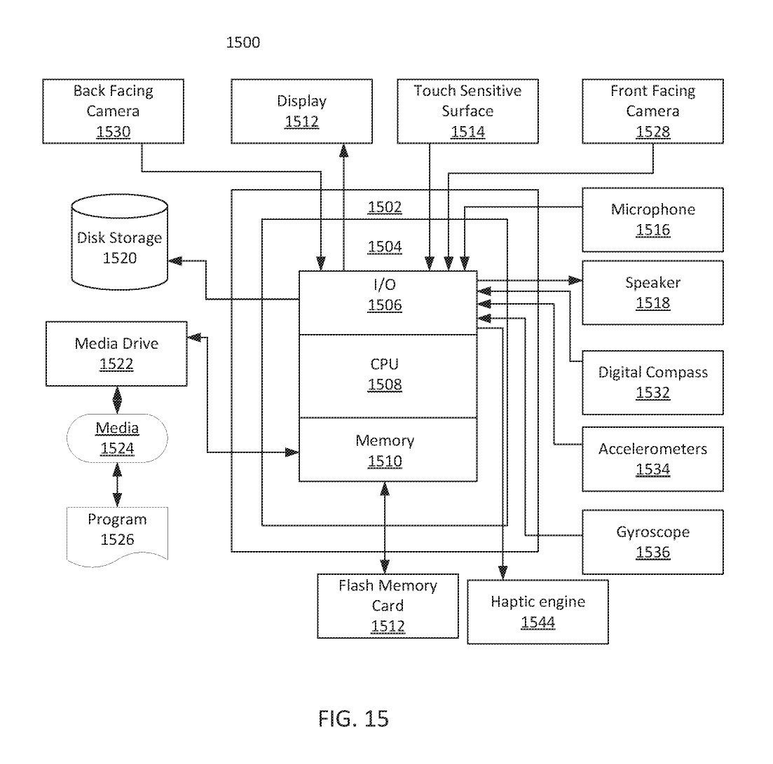

FIG. 1 depicts smart device 100 that can implement embodiments of the present technology. In some examples, smart device 100 is a smart phone or tablet computing device but the present technology can also be implemented on other types of electronic devices, such as wearable devices or a laptop computer. In some embodiments smart device 100 is similar to and includes all or some of components of computing system 1500 described below in FIG. 15. In some embodiments, smart device 100 includes touch sensitive display 102 and back facing camera 124. In some embodiments, smart device 100 also includes front-facing camera 120 and speaker 122. Smart device 100 optionally also includes other sensors, such as microphones, movement/orientation sensors (e.g., one or more accelerometers, gyroscopes, digital compasses, etc.), depth sensors (which are optionally part of camera 120 and/or camera 124), etc.

FIG. 2 depicts screenshot 200 showing an example IAR background 200, which is being displayed on the display of a smart device, such as display 102 of smart device 100. IAR background 202 is a simple background that is only an image captured from a back-facing camera of the smart device, such as back-facing camera 124 of smart device 100. Other IAR backgrounds optionally include other images, such as computer generated images. Other real objects, such people or a user's hands, face, etc. can also be included in an IAR background.

FIG. 3 depicts screenshot (e.g., being display on display 102 of smart device 100) of an example IAR view 300 with IAR background 202 and an IAR object in the form of virtual creature 302. The smart device displaying IAR view 300 generates and displays creature 302 according to predetermined rules. For example, creature 302 optionally is an image generate from a user avatar associated with the creature. In some cases the user of the smart device displaying IAR view 300 is interacting with another user of another smart device. Creature 302 is optionally generated based on information (e.g., avatar information or an image) associated with the other user. For example, in some instances, the information is transferred directly from the other user. In other instances, the information is transferred from a central server that stores profile data for the other user including avatar data or other data that can be used to generate creature 302. In other examples, creature 300 is generated independently of information associated with another user even though the other user is optionally controlling creature 302.

Still referring to FIG. 3, the location of creature 302 is optionally based on various factors. For example, in some cases, creature 302 is placed in the same position on the display (e.g., display 102 of smart device 100) regardless of the IAR background or other image that is currently being displayed. For example, if creature 302 is represented by an image, the image is optionally placed at a predetermined location on the display, such as a predetermined x- and y-coordinates defined by pixels or distances (e.g., from the bottom left corner of the display). In other cases, the smart device places creature 30s at a location based on an analysis of IAR background 202. For instance, the smart device optionally analyzes the image data that makes up IAR background 20s to identify a location of interest (e.g., an edge of furniture or a wall, a recognizable location, or a particularly good hiding spot) and places creature 302 based on the location of interest (e.g., at the location, near the location, some predetermined distance from the location).

FIG. 4 depicts a screenshot of IAR background 202 and a snapshot of IAR gesture of hand 402 being captured with the camera of the smart device (such as back-facing camera 124 of smart device 100). The gesture includes user hand 400 making a pinching gesture as depicted in FIG. 4. Detecting the gesture, in some cases, includes performing image processing on image data (still image data or video data) captured from an image sensor, such as a back-facing image sensor of a smart device. To assist in detecting a gesture, the image data optionally or alternatively includes depth information that is capture from or derived from the data generated by the image sensor. Alternatively, depth information associated with the image data is captured from a sensor (e.g., IR sensor, time-of-flight sensor, etc.) different than the image sensor. In some cases, the smart device recognizes the gesture based on a trained artificial intelligence routine (e.g., using machine learning) using training data from the user of the smart device or from multiple users using various different devices.

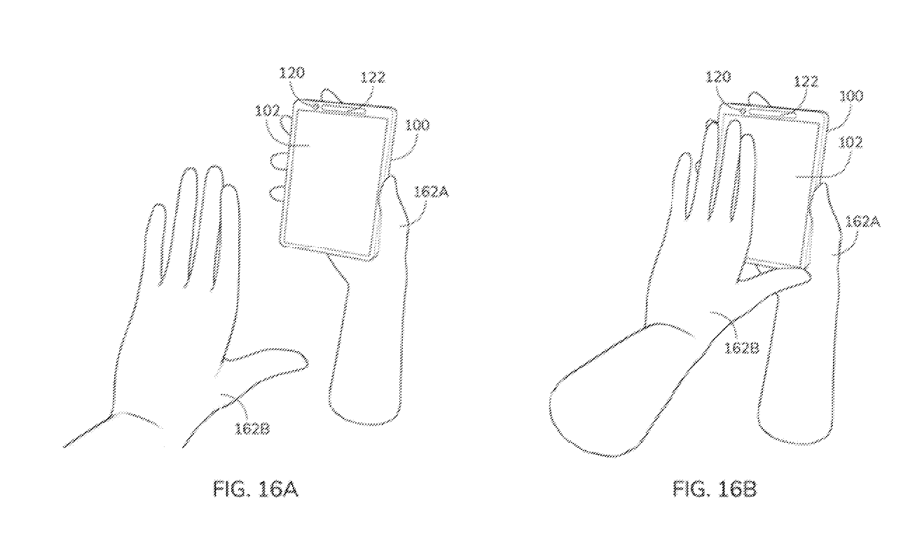

In other embodiments, other gestures can be used in addition to or instead of gestures detected with an image sensor. For example, gestures can be detected using a touch screen or motion sensors (e.g., accelerometers, gyroscopes, electronic compasses, etc.). Additionally, data from multiple sensors (e.g., depth data and image data or image data and movement data) can be combined together to detect a particular gesture. Multiple gestures can also be linked together to create new gestures. Examples of gestures that can be used in embodiments of the present technology are described below with respect to FIGS. 16-19. These gestures can be combined together or with other gesture to create a sophisticated and immersive user interaction with the AR environment.

FIG. 5 depicts a screenshot of an IAR view 500 that includes components from FIGS. 2-4. Specifically, IAR view 500 includes IAR background 202 from FIG. 2, IAR object 302 from FIG. 3, and IAR gesture based on hand 402 from FIG. 4.

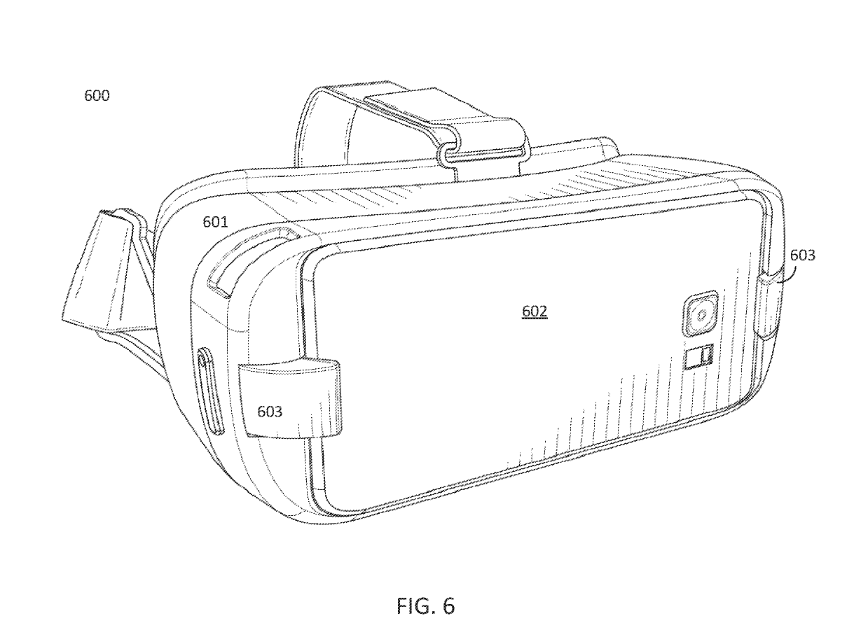

FIG. 6 depicts goggle 600, which is an example of an AR/VR goggle with a back facing camera. For example, goggle 600 includes head mount 601 and smart device 602, which can be implemented as smart device 100 mounted to goggle mount 601. Alternatively, the goggles have built-in electronics that provide the same functionality as smart device 100. In this example with smart device 600 is a smart phone connected to a goggle mount 601, which is a headset. Smart device 600 includes a display (e.g., display 102) that displays graphics and other information that can be seen through the eye pieces of the headset.

In an embodiment of the invention, a game allows for players to throw bombs to each other, and each of them can attempt to avoid being hit. This can be done from a first-person perspective.

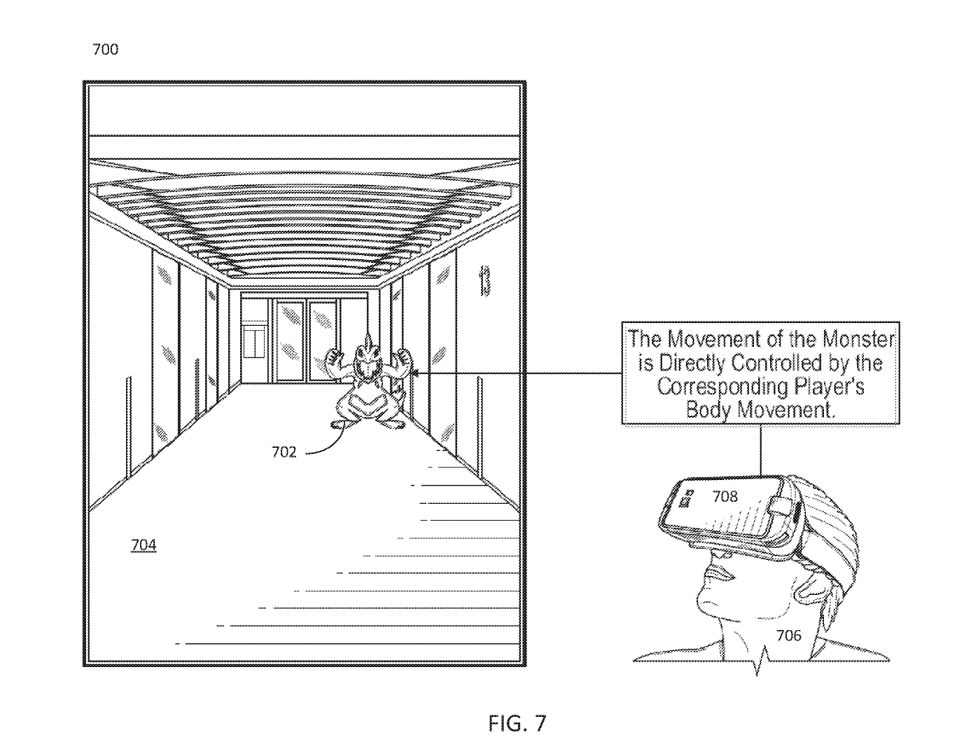

In one example, two players (who could be located in different parts of the world and are connected through the Internet) are playing a first-person interactive AR game in which each of them controls a corresponding IAR object (e.g., a creature) in the AR environment and are displayed on the other user's smart device display in a first-person-role-playing manner, such depicted in FIG. 7. IAR view 700 with creature 702 overlaid on IAR background 704 is being displayed on the display of a user's smart device display. Remote user 706 is wearing AR googles 708 that includes another smart device. As remote user 706 moves AR goggles 708, creature 702 moves in response to data being transmitted from remote user 706's smart device. In other examples, the remote user has a handheld smart device and movements transmitted to the other user are based on the remote user's hand or entire body, for example, moving the smart device.

In this example the players play the game by throwing bombs at each other. A player scores if his bomb hits the opposite player.

In this example game, the 2 players are called Player-A (“P-A”) and Player-B (“P-B”). As the game begins, the smart devices of P-A and P-B register their current locations as their corresponding reference points. We call these reference points Ref-A and Ref-B respectively. In some cases, the reference point is predetermined by a developer of the present invention or a manufacturer of smart device 100. For example, the reference point is predetermined as the center of touch transition display 102 of smart device 100. There is no limitation on the location of reference point. The reference point may be bottom left corner, bottom right corner, or any points of touch sensitive display 102 of smart device 100. When P-A moves (or moves the smart device) sideways from Ref-A, his smart device will record the displacement (e.g., with one or more of an accelerometer, gyroscope, of electronic compass of a smart device) with direction from Ref-A (e.g., 2 meters to the left). Below, we call this displacement Disp-A. Similarly, the displacement of P-B from Ref-B is called Disp-B.

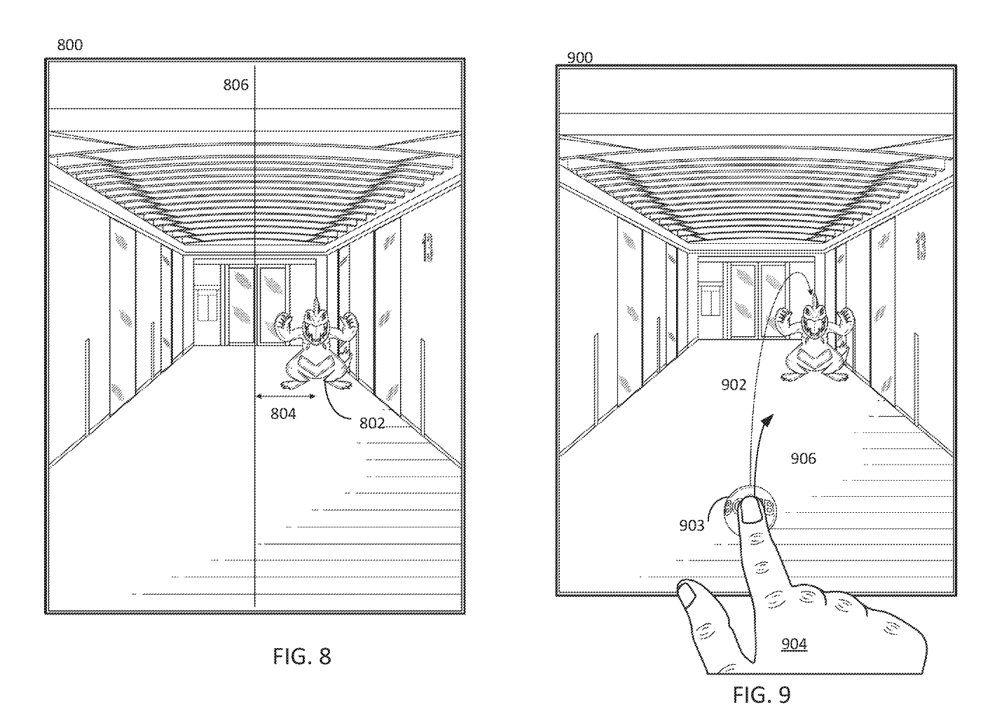

FIG. 8 illustrates the calculation of the displacement of the IAR object controlled by P-B (seen on P-A's screen). Specifically, in IAR view 800 of FIG. 8, creature 802 is displaced by amount 804, which is based on a distance (e.g., pixels or other distance measurement) from a reference location in IAR view 800 (e.g., reference line 806, which in some cases is the center location of IAR view 800 or the AR environment). In other words, the distance that a player associated with creature 802 moves (e.g., as determined form data received from the player associated with creature 802) will be used to determine how far an IAR object, such as creature 802 will move (such as how far from a reference line) on the display on the smart device display.

During one example game, P-A sees P-B as a virtual object (e.g., a creature, monster, or other object) on the smart device display (e.g., coupled to the AR/VR goggle or the display as the smart device is being held), and tries to throw one or more bombs to hit P-B using, as an example, one of the following ways:

(1) Finger gesture over the touch sensitive screen of the smart device—P-A uses his finger to swipe the screen at a particular angle aiming at P-B (as shown in FIG. 9). This method is suitable when the game is played on a non-wearable smart device (i.e., on a normal smart phone). The IAR gesture here is detected by the touch screen sensor. FIG. 9 depicts an example of this gesture on a touch screen 900 (such as touch sensitive display 102 of smart device 100). Path 902 shows the path virtual object 903 (e.g., a virtual bomb) will take in response to a drag and release gesture of hand 904 making a gesture along the touch screen, as indicated by arrow 906. An animation showing virtual object 903 moving across the IAR view can represent the virtual object traveling through the AR environment based on data from the user's gesture.

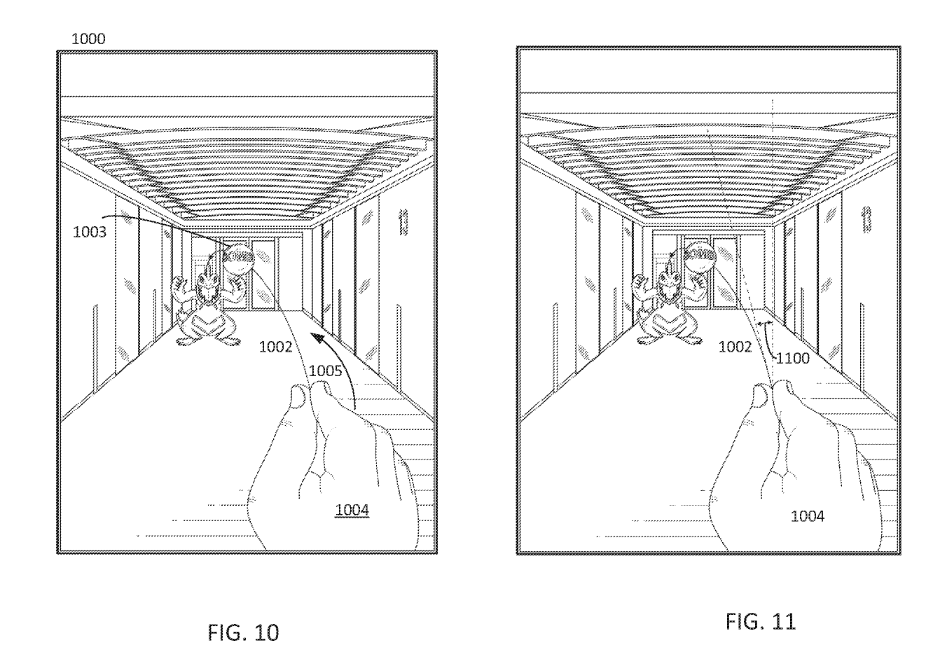

(2) Hand gesture recognition in front of the back-facing camera—P-A places one of his hands in front of the back-facing camera and perform a throwing gesture toward a particular angle aiming at P-B (as shown in FIG. 10). This method is most suitable when P-A is playing the game on a wearable device, such as an AR/VR goggle, where on-screen finger gesture is not possible, but it can also be used when the smart device is hand held. FIG. 10 depicts an example of this gesture. Screenshot 1000 shows what a user might see while looking at a display of AR goggles. Virtual bomb 1003 travels along path 1002 based on the motion (represented by arrow 1005) of hand 1004 as detected by a back-facing camera of the smart device. Other factors besides the hand motion can also be detected and used to determine the trajectory of the bomb, including when a second, different gesture is made (e.g., when a pinch release gesture is made to release the bomb), the speed of the gesture, or the orientation of the smart device.

Examples others gestures that can be used in embodiments of the present technology are described below with respect to FIGS. 16-19.

While P-A throws the bomb(s), metadata containing, for example, some or more of the following information will be transmitted to P-B or a server, which will calculate a result based on the information, through the Internet connection for each bomb thrown:
Angle: angle 1100 that the bomb is thrown, for example, as determined by (or proportional to) the angle of the user's hand motion (e.g., as depicted in FIG. 11).
Speed: the speed that the bomb is thrown, for example, as determined by (or proportional to) the speed of the user's hand.
Direction: the direction that the bomb is thrown, for example, as determined by (or proportional to) the direction of the user's hand.

When P-B's smart device receives this metadata (or other movement data based on the metadata) or a resulting path based on the above metadata, it will convert it into the data required to play the game (e.g., angle of an incoming bomb being thrown to P-B). P-B, as the opposite player in the game against P-A, sees the bombs thrown from P-A in, for example, one of the following two ways:

(1) With a non-wearable or hand-held smart device such is a normal smartphone—P-B sees the bomb(s) being thrown to him in various angles on his/her screen of the smart device. If one or more bombs hits, for example, the middle mark on his screen, then P-B is considered to be hit, and will lose a score (P-A gets a score). Otherwise, P-B will see the bombs coming through to the left-hand-side or right-hand-side of his screen at an angle, and the bombs are considered to miss the target. P-B moves his/her smart device sideways to avoid to be hit by the bombs.

(2) With a wearable smart device such as an AR/VR goggle—P-B sees the bombs being thrown to his head directly. If one or more bombs hits head-on, for example, perpendicularly with the trajectory, then P-B is considered to be hit, and will lose a score (P-A gets a score). Otherwise, P-B will see the bombs coming through to the left-hand-side or right-hand-side of his head at an angle, and the bombs are considered to miss the target. P-B, with his wearable device on, moves entire body sideways to avoid to be hit by the bombs.

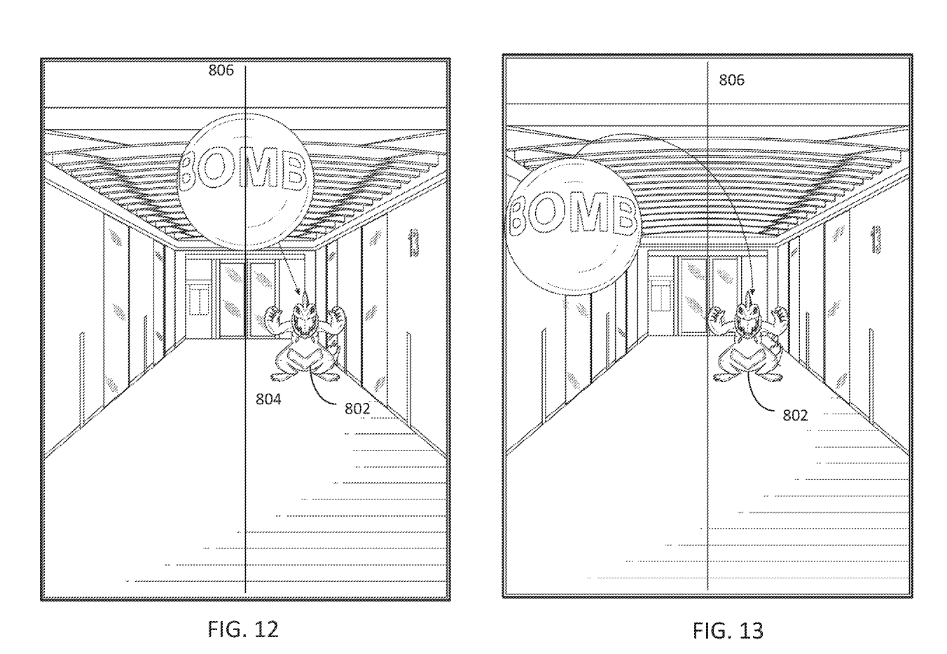

FIGS. 12 and 13 (which build on the description of FIG. 8) depict the cases of a target hit and a target miss. In FIG. 12, while P-B moves sideway to escape from being hit (as shown in FIG. 13), one or more of the following metadata (e.g., movement data) could be sent to P-A (or to an intermediary that then send additional data based on the metadata or the meta data itself) through the Internet or other network:

Displacement: Disp-B from Ref-B

Direction: Left, Right, Forward or Backward from Ref-B

When P-A's smart device receives this metadata from P-B over the Internet, it will update the position of the IAR object representing P-B on the display using based on this data, so that P-A will actually see the IAR object moving in a manner that corresponds to the way P-B moved. As a result, P-A can adjust the throwing angle in the next attempt. The smart device optionally generates the AR environment before displaying a particular IAR view. In this example, the smart device moves the virtual object from a first location within the AR environment to a second location within the AR environment while generating an update to the AR environment.

Of course, P-B can also throw bomb(s) to P-A at in the same manner while he/she escapes from being hit, and P-A can also escape from being hit while he throws bomb(s) to P-B. In this case (i.e., both P-A and P-B are throwing bombs to each other while both of them are moving to avoid being hit), both of them will receive the following metadata:

Angle: the angle that the bomb is thrown towards himself;

Displacement: Disp-A/Disp-B from the Ref-A/Ref-B

Direction: Left, Right, Forward or Backward from Ref-B/Ref-A

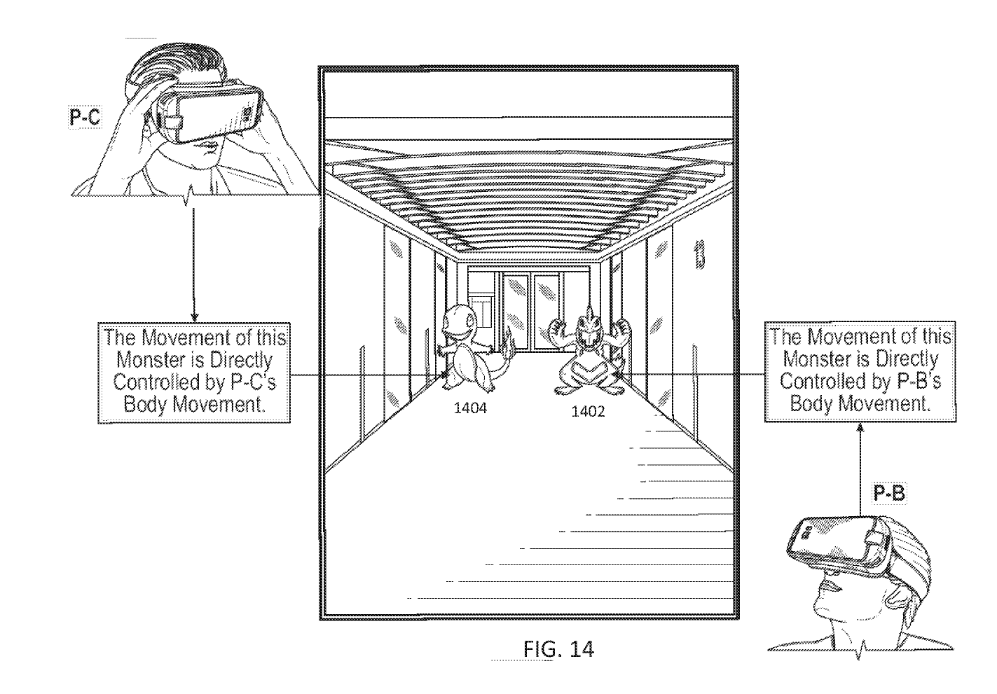

In some embodiments, there can be more than 2 players in the game. For example, player, P-C, can join the game that P-A and P-B are playing. In this case, the attacker (i.e., the player who throws the bomb) will see two virtual objects on his screen being overlaid to his IAR Background, and will throw a bomb to any one of them. For instance, if we consider P-A's point of view, P-A will see two IAR Objects (virtual objects), one controlled by P-B and one controlled by P-C, on his screen overlaid on his IAR Background. The reference points of P-B and P-C, Ref-B and Ref-C respectively, are set to the middle point of P-A's screen. Either IAR Object can move fully independently to another IAR Object, and P-A can aim at either one at his will. The rest of the game can be similar to the 2-player game. In the same manner, the game can actually be extended to N-player game, where N is only limited by the hardware resources such as screen size, CPU power, network bandwidth, etc. FIG. 14 depicts a 3-Player game, from the view of P-A. The game also includes player P-B and P-C. P-B controls create 1402 and P-C controls create 1404.

Turning now to FIG. 15, components of an exemplary computing system 1500, configured to perform any of the above-described processes and/or operations are depicted. For example, computing system 1500 may be used to implement smart device 100 described above that implements any combination of the above embodiments or process 1500 described below with respect to FIG. 15. Computing system 1500 may include, for example, a processor, memory, storage, and input/output peripherals (e.g., display, keyboard, stylus, drawing device, disk drive, Internet connection, camera/scanner, microphone, speaker, etc.). However, computing system 1500 may include circuitry or other specialized hardware for carrying out some or all aspects of the processes.

In computing system 1500, the main system 1502 may include a motherboard 1404, such as a printed circuit board with components mount thereon, with a bus that connects an input/output (I/O) section 1506, one or more microprocessors 1508, and a memory section 1510, which may have a flash memory card 1512 related to it. Memory section 1510 may contain computer-executable instructions and/or data for carrying out any of the other process described herein. The I/O section 1506 may be connected to display 1512 (e.g., to display a view), a touch sensitive surface 1514 (to receive touch input and which may be combined with the display in some cases), a microphone 1516 (e.g., to obtain an audio recording), a speaker 1518 (e.g., to play back the audio recording), a disk storage unit 1520, a haptic feedback engine 1444, and a media drive unit 1522. The media drive unit 1522 can read/write a non-transitory computer-readable storage medium 1524, which can contain programs 1526 and/or data used to implement process 1500 or any of the other processes described above or below. Computing system 1500 also includes one or more wireless or wired communication interfaces for communicating over data networks.

Additionally, a non-transitory computer-readable storage medium can be used to store (e.g., tangibly embody) one or more computer programs for performing any one of the above-described processes by means of a computer. The computer program may be written, for example, in a general-purpose programming language (e.g., Pascal, C, C++, Java, or the like) or some specialized application-specific language.

Computing system 1500 may include various sensors, such as front facing camera 1528 and back facing camera 1530. These cameras can be configured to capture various types of light, such as visible light, infrared light, and/or ultra violet light. Additionally, the cameras may be configured to capture or generate depth information based on the light they receive. In some cases, depth information may be generated from a sensor different from the cameras but may nonetheless be combined or integrated with image data from the cameras. Other sensors included in computing system 1500 include digital compass 1532, accelerometer 1534, and/or gyroscope 1536. Other sensors and/or output devices (such as dot projectors, IR sensors, photo diode sensors, time-of-flight sensors, etc.) may also be included.

While the various components of computing system 1500 are depicted as separate in FIG. 15, various components may be combined together. For example, display 1512 and touch sensitive surface 1514 may be combined together into a touch-sensitive display.

In some examples of the present technology, P-A makes a hand gesture before smart device 100 (in some cases when smart device 100 is mounted in a goggles for wearing on the user's head) in order to interact with P-B. The embodiments or the combination of the embodiments below may also be applied to smart device 100 of P-B when P-B makes the hand gesture mentioned below.

For example, as shown in FIG. 16A, P-A holds smart device 100 in hand 162A with the front side of smart device 100 facing the P-A. P-A moves bare hand 162B towards the front side of smart device 100, as demonstrated in FIG. 16B. A proximity sensor of smart device 100 is adapted to detect the distance, and/or changes in the distance, between hand 162B and the front side of smart device 100. A proximity sensor may be one of a number of well-known proximity sensors known and used in the art, and it may be used, e.g., to detect the presence of nearby objects without any physical contact. As is known in the art, a proximity sensor often emits an electromagnetic or electrostatic field, or a beam of electromagnetic radiation. In some examples, when the distance is equal to or less than a pre-defined threshold, a pre-defined action will be performed by smart device 100.

Merely by way of example, the pre-defined threshold can be about 10 mm. When hand 162B is positioned equal to or less than about 10 mm from the front side of smart device 100, the pre-defined action will be performed. It is noted that there is no limitation on the distance between hand 162B and the front side of smart device 100. For instance, the pre-defined threshold may be 20 mm, 30 mm or 50 mm.

In some examples, the pre-defined action includes that a virtual object appears on a touch sensitive screen of smart device 100 and energy beams are emitted therefrom. There is no limitation on the action performed by smart device 100. For instance, the pre-defined action may be a ball throwing, a missile attack, a gun shooting, or other graphics and animation being displayed at the smart device 100. Additionally and/or alternatively, the pre-defined action may further include, for example, output of audible and/or haptic feedback generated or otherwise output at the device 100.

At the time that the pre-defined action is performed by smart device 100, metadata containing, for example, some or more of the following information will be transmitted to P-B through the Internet connection for each emission of energy beams:

Angle: the angle that the energy beams are emitted, for example, as determined by (or proportional to) the angle of P-A's hand.

Speed: the speed that the energy beams are emitted, for example, as determined by (or proportional to) the speed of P-A's hand.

Direction: the direction that the energy beams are emitted, for example, as determined by (or proportional to) the direction of P-A's hand.

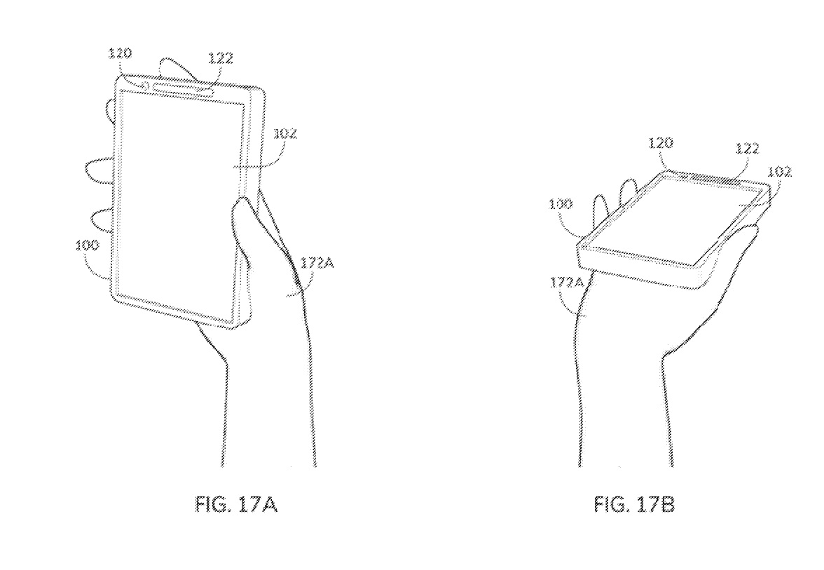

Turning now to FIG. 17A, in some examples of the present technology, P-A holds smart device 100 upright in hand 172A. The upright position of smart device 100 is considered as a first position. P-A rotates hand 172A to cause smart device 100 moving from the first position to a second position, as shown in FIG. 17B. For example, smart device 100 is rotated to the second position, which is substantially 90 degree from the first position, as illustrated in FIG. 17B. Smart device 100 may include a gyroscope (e.g., gyroscope 1438) which is adapted to detect change of orientation of smart device 100.

When smart device 100 changes its orientation, for example, moving from the first position to the second position, a pre-defined action will be performed by smart device 100. For example, the pre-defined action may include that a virtual object appears on a touch sensitive display of smart device 100 and shooting fluid is shot therefrom. There is no limitation on the pre-defined action. For example, the pre-defined action may be a ball throwing, a missile attack or a gun shooting, or other graphics and animation being displayed at the smart device 100. Additionally and/or alternatively, the pre-defined action may further include, for example, output of audible (e.g., via speaker 1418 and/or headphones connected to the device 100) and/or haptic feedback (e.g., via haptic feedback engine 1444 at the device 100) generated or otherwise output at the device 100.

At the time that the pre-defined action is performed by smart device 100, meta-data will be transmitted to P-B through the Internet. There is no limitation on the first position and the second position of smart device 100. The first position may be an inclined position relative to hand 172A and the second position may be an upright position.

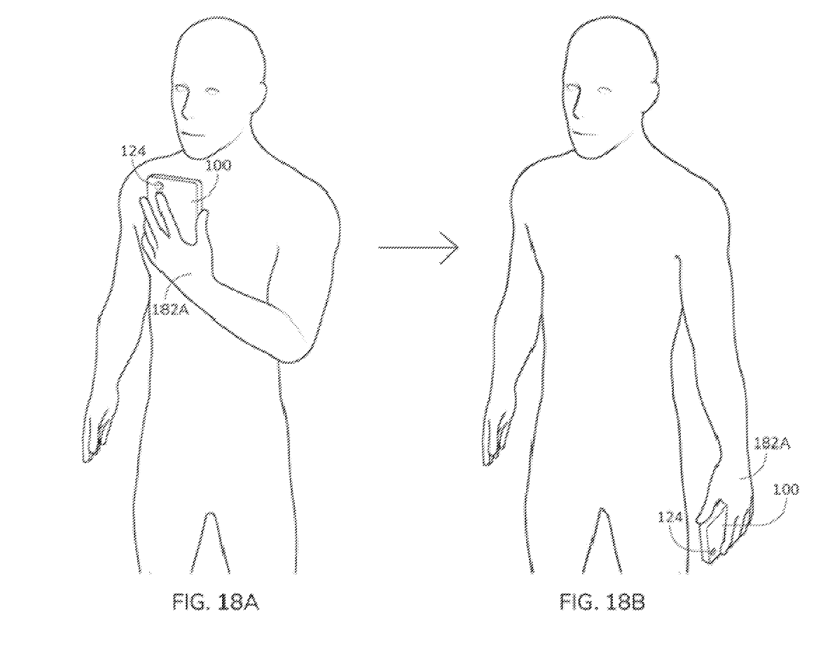

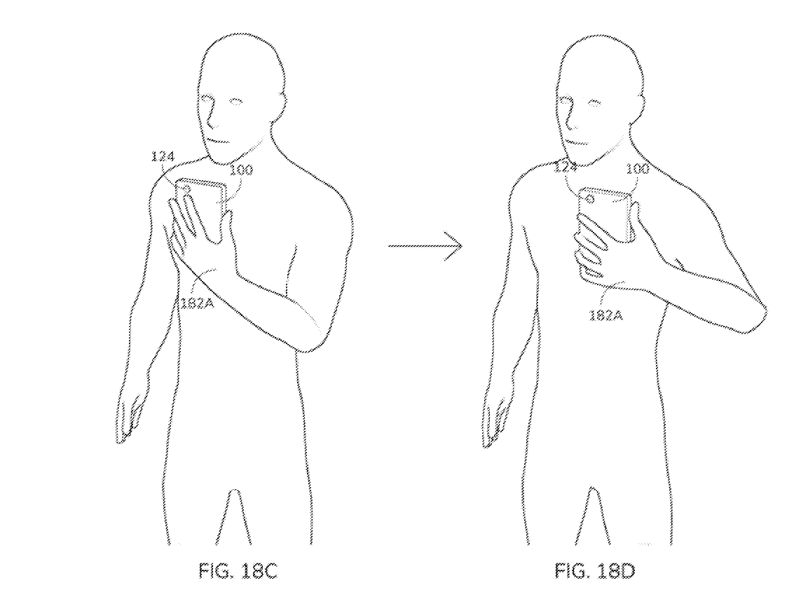

Turning now to FIG. 18A, in some examples of the present technology, P-A holds smart device 100 in hand 182A at a first position. P-A moves smart device 100 from the first position to a second position in an accelerated manner, as shown at FIG. 18B. Smart device 100 includes an accelerometer (e.g., accelerometer 1434) which is adapted to detect acceleration of smart device 100.

For example, as illustrated in FIG. 18A, P-A moves smart device 100 across his/her chest and up to a shoulder position which is considered as the first position. As illustrated in FIG. 18B, P-A then starts to move smart device 100 from the first position down to a thigh position of P-A in an accelerated manner and stops moving at the thigh position. The thigh position is considered as the second position.

In further examples, as illustrated in FIG. 18C, P-A moves smart device 100 up to one side of his/her chest that is considered as the first position. As illustrated in FIG. 18D, P-A then starts to move smart device 100 from the first position to the second position in an accelerated manner and stops moving at the second position. The second position may be the other side of the chest.

When smart device 100 moves from the first position to the second position in accelerated manner, an acceleration value will be generated by smart device 100. When the accelerometer of smart device 100 detects the acceleration value being equal to or greater than a pre-defined threshold (e.g., a pre-defined threshold value of 0.7), a pre-defined action will be performed by smart device 100 and meta-data will also be transmitted to P-B through the Internet.

There is no limitation on the pre-defined threshold. For instance, the pre-defined threshold may be 0.75, 0.8 or 0.9. The pre-defined action may include that a virtual object appears on a touch sensitive display of smart device 100 and a shield is thrown out therefrom. There is no limitation on the pre-defined action. For instance, the pre-defined action may be a ball throwing, a missile attack or a gun shooting, or other graphics and animation being displayed at the smart device 100. Additionally and/or alternatively, the pre-defined action may further include, for example, output of audible (e.g., via speaker 1418 and/or headphones connected to the device 100) and/or haptic feedback (e.g., via haptic feedback engine 1444 at the device 100) generated or otherwise output at the device 100.

There is no limitation on the first position and the second position where smart device 100 is located respectively. For instance, the first position may be an overhead position and the second position may be a hip position.

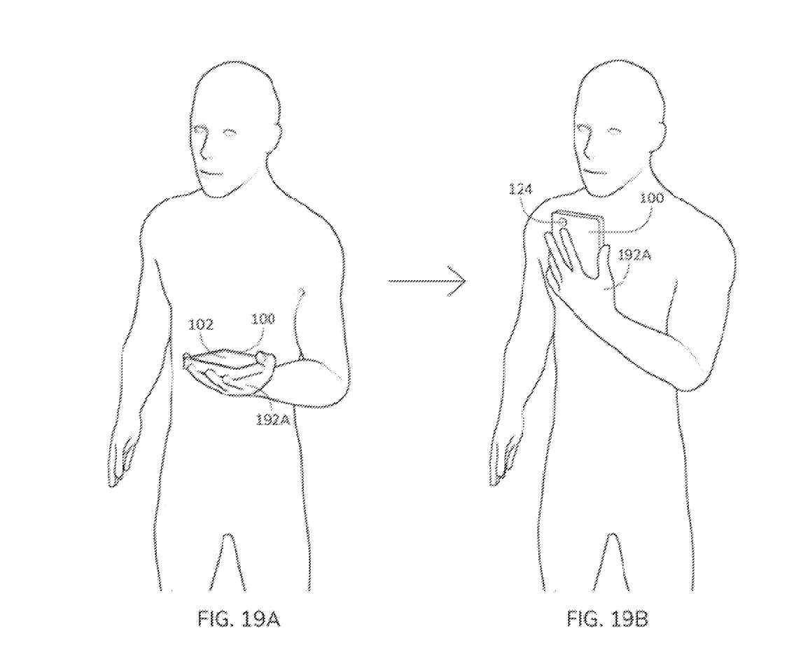

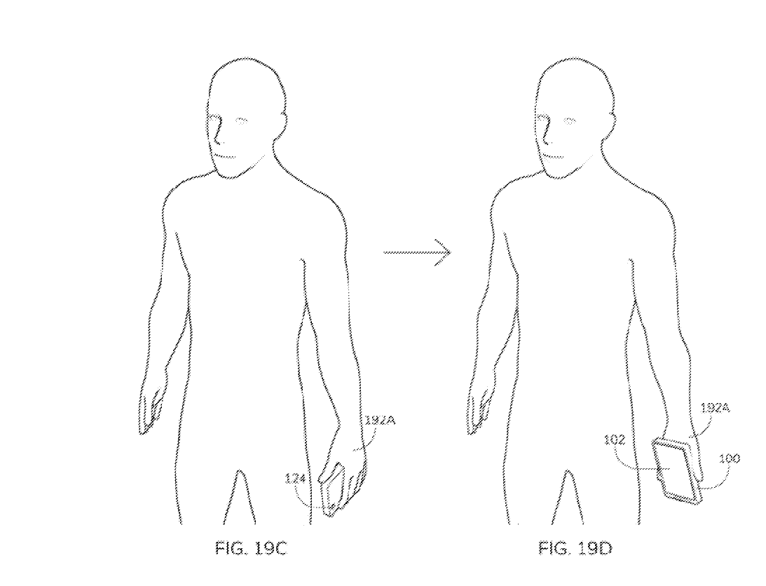

Turning now to FIG. 19A, in some examples, P-A holds smart device 100 in hand 192A. As illustrated in FIG. 19B, P-A moves smart device 100 across his/her chest and up to a shoulder position or even above, which may be a first position. The front side of smart device 100 faces P-A.

P-A then moves smart device 100 from the first position down to a second position in an accelerated manner and stops moving at the second position as illustrated in FIG. 19C. For example, the second position may be a thigh position of P-A. When smart device 100 is at the second position, P-A rotates hand 192A to cause smart device 100 to change its orientation as illustrated in FIG. 19D.

At the time that smart device 100 changes its orientation the gyroscope of smart device 100 detects the change of orientation. A pre-defined action will then be performed by smart device 100 and meta-data will also be transmitted to P-B through the Internet. The pre-defined action may include that a virtual object appears on a touch sensitive display of smart device 100 and a shield is thrown out therefrom. There is no limitation on the pre-defined action. The pre-defined action may be a ball throwing, a missile attack or a gun shooting, or other graphics and animation being displayed at the smart device 100. Additionally and/or alternatively, the pre-defined action may further include, for example, output of audible (e.g., via speakers and/or headphones connected to the device 100) and/or haptic feedback (e.g., via haptic feedback engine at the device 100) generated or otherwise output at the device 100.

Exemplary methods, non-transitory computer-readable storage media, systems, and electronic devices are set out in the following implementations:

1. A method comprising:

at an electronic device having a display and one or more image sensors:
receiving position data indicating the position of a remote user;
generating an augmented reality (AR) environment based on the position data and image data from the one or more image sensors;
detecting a gesture of the user of the electronic device using a sensor of the electronic device;
updating the generated AR environment based on a characteristic of the detected gesture; and
transmitting information about the characteristic to a remote device associated with the remote user.

2. The method of implementation 1 further comprising:
displaying the generate AR environment on the display of the electronic device.

3. The method of implementation 1 or implementation 2, wherein the sensor is the one or more image sensors.

4. The method of any one of implementations 1-2, wherein the sensor is an external sensor connected to the electronic device.

5. The method of any one of implementations 1-2 or 4, wherein the sensor is handheld.

6. The method of any one of implementations 1-5, wherein generating the AR environment includes positioning a virtual object associated with the remote user in the AR in a location with respect to image data captured with the one or more image sensors based on the received position data.

7. The method of any one of implementations 1-6 further comprising:
receiving remote user data associated with the remote user from the remote user; and
updating the generated AR environment based on the received remote user data.

8. The method of implementation 7, wherein the remote user data is based on a characteristic of a gesture of the remote user.

9. The method of implementation 8, wherein the characteristic is a speed, direction, or angle of the gesture.

10. The method of implementation 7, wherein the remote user data is based on movement of the remote user.

11. The method of any one of implementations 1-10, wherein the gesture is a hand gesture.

12. The method of any one of implementations 1-10, wherein the gesture is a finger gesture.

13. A non-transitory computer-readable storage medium encoded with a computer program executable by an electronic device having a display on one side of the device and one or more image sensors, the computer program comprising instructions for performing the method of any one of implementations 1-12.

14. An electronic device comprising:

a display on one side of the device;

one or more image sensors;

a processor; and

memory encoded with a computer programming having instructions executable by the processor, wherein the instructions for performing the method of any one of implementations 1-12.

Exemplary methods, non-transitory computer-readable storage media, systems, and electronic devices are set out in the following items:

1. A method comprising:

at an electronic device having a display and one or more image sensors:

displaying on the display a view of an augmented reality (AR) environment, wherein the AR environment includes a background based on captured image data from the one or more image sensors and a first virtual object at a first location and the view includes display of the first virtual object;

receiving movement data indicating movement of a remote user;

determining a property of the first virtual object in the AR environment based on the received data; and

updating the display of the view based on the determined property.

2. The method of item 1, wherein determining the property of the first virtual object includes determining that the first virtual object is at a second location different than the first location, and wherein updating the display of the view includes display the first virtual object in a different position based on the second location.

3. The method of item 2, wherein a magnitude of the difference between the first location and second location is based on a magnitude in the movement data.

4. The method of item 2 or 3, wherein a direction of the second location with respect to the first location is based on directional data in the movement data.

5. The method of any one of items 2-4, wherein the different position is determined based on a reference location in the AR environment.

6. The method of item 5, wherein the reference line corresponds to a location at the middle of the AR environment as displayed in the view.

7. The method of any one of items 1-6 further comprising:

detecting one or more gestures of the user of the electronic device using one or more sensors of the electronic device;

determining first data based on one or more properties of the one or more gestures;

transmitting the first data to the remote user.

8. The method of item 7 further comprising:

updating the display of the view to include a second virtual object moving through the AR environment based on the one or more gestures.

9. The method of item 7 further comprising:

updating the display of the view to include a second virtual object moving through the view corresponding to the second virtual object moving through the AR environment based on the first data.

10. The method of any one of items 1-9 further comprising:

generating the AR environment based on the captured image data.

11. The method of any one of items 7-10, wherein the one or more sensors includes the one or more image sensors.

12. The method of any one of items 7-11, wherein the one or more sensors includes is an external sensor connected to the electronic device.

13. The method of any one of items 7-12, wherein the one or more sensors includes a touch-sensitive surface.

14. The method of any one of items 1-12, wherein the electronic device is a handheld device or a head mounted device.

A non-transitory computer-readable storage medium encoded with a computer program executable by an electronic device having a display on one side of the device and one or more image sensors, the computer program comprising instructions for performing the method of any one of items 1-14.

An electronic device comprising:

a display;

one or more image sensors;

a processor; and

memory encoded with a computer programming having instructions executable by the processor, wherein the instructions for performing the method of any one of items 1-14.

Various exemplary embodiments, implementations, and items are described herein. Reference is made to these examples in a non-limiting sense. They are provided to illustrate more broadly applicable aspects of the disclosed technology. Various changes may be made and equivalents may be substituted without departing from the true spirit and scope of the various embodiments. In addition, many modifications may be made to adapt a particular situation, material, composition of matter, process, process act(s) or step(s) to the objective(s), spirit or scope of the various embodiments. Further, as will be appreciated by those with skill in the art, each of the individual variations described and illustrated herein has discrete components and features which may be readily separated from or combined with the features of any of the other several embodiments without departing from the scope or spirit of the various embodiments.

What is claimed is:

1. A method comprising:
at an electronic device having a display and one or more image sensors:
displaying on the display a view of an augmented reality (AR) environment, wherein the AR environment includes a background based on captured image data from the one or more image sensors and a first virtual object at a first location and the view includes display of the first virtual object;
receiving movement data indicating movement of a remote user;
determining a property of the first virtual object in the AR environment based on the received data; and
updating the display of the view based on the determined property.

2. The method of claim 1, wherein determining the property of the first virtual object includes determining that the first virtual object is at a second location different than the first location, and wherein updating the display of the view includes display the first virtual object in a different position based on the second location.

3. The method of claim 2, wherein a magnitude of the difference between the first location and second location is based on a magnitude in the movement data.

4. The method of claim 2, wherein a direction of the second location with respect to the first location is based on directional data in the movement data.

5. The method of claim 2, wherein the different position is determined based on a reference location in the AR environment.

6. The method of claim 5, wherein the reference line corresponds to a location at the middle of the AR environment as displayed in the view.

7. The method of claim 1 further comprising:
detecting one or more gestures of the user of the electronic device using one or more sensors of the electronic device;
determining first data based on one or more properties of the one or more gestures;
transmitting the first data to the remote user.

8. The method of claim 7 further comprising:
updating the display of the view to include a second virtual object moving through the AR environment based on the one or more gestures.

9. The method of claim 7 further comprising:
updating the display of the view to include a second virtual object moving through the view corresponding to the second virtual object moving through the AR environment based on the first data.

10. The method of claim 1 further comprising:
generating the AR environment based on the captured image data.

11. The method of claim 7, wherein the one or more sensors includes the one or more image sensors.

12. The method of claim 7, wherein the one or more sensors includes is an external sensor connected to the electronic device.

13. The method of claim 7, wherein the one or more sensors includes a touch-sensitive surface.

14. The method of claim 1, wherein the electronic device is a handheld device or a head mounted device.

15. A non-transitory computer-readable storage medium encoded with a computer program executable by an electronic device having a display on one side of the device and one or more image sensors, the computer program comprising instructions for:
displaying on the display a view of an augmented reality (AR) environment, wherein the AR environment includes a background based on captured image data from the one or more image sensors and a first virtual object at a first location and the view includes display of the first virtual object;
receiving movement data indicating movement of a remote user;
determining a property of the first virtual object in the AR environment based on the received data; and
updating the display of the view based on the determined property.

16. The non-transitory computer-readable storage medium of claim 15, wherein determining the property of the first virtual object includes determining that the first virtual object is at a second location different than the first location, and wherein updating the display of the view includes display the first virtual object in a different position based on the second location.

17. The non-transitory computer-readable storage medium of 16, wherein a magnitude of the difference between the first location and second location is based on a magnitude in the movement data.

18. The non-transitory computer-readable storage medium of 16, wherein a direction of the second location with respect to the first location is based on directional data in the movement data.

19. The non-transitory computer-readable storage medium of 16, wherein the different position is determined based on a reference location in the AR environment.

20. An electronic device comprising:
a display;
one or more image sensors;
a processor; and
memory encoded with a computer programming having instructions executable by the processor, wherein the instructions for:
displaying on the display a view of an augmented reality (AR) environment, wherein the AR environment includes a background based on captured image data from the one or more image sensors and a first virtual object at a first location and the view includes display of the first virtual object;
receiving movement data indicating movement of a remote user;
determining a property of the first virtual object in the AR environment based on the received data; and
updating the display of the view based on the determined property.
